(19) United States
(12) Patent Application Publication
(10) Pub. No.: US 2024/0001693 A1
(43) Pub. Date: Jan. 4, 2024

(54) ADJUSTING IMAGES BASED ON MEDIA DEFORMATION

(71) Applicant: Hewlett-Packard Development Company, L.P., Spring, TX (US)

(72) Inventors: Ricard EJARQUE MONTALVO, Sant Cugat del Valles (ES); Victor LORENTE TEJERO, Sant Cugat del Valles (ES); David MUNOZ NAVARRO, Sant Cugat del Valles (ES); Albert ESTELLA AGUERRI, Sant Cugat del Valles (ES)

(73) Assignee: Hewlett-Packard Development Company, L.P., Spring, TX (US)

(21) Appl. No.: 18/253,831

(22) PCT Filed: Dec. 23, 2020
(86) PCT No.: PCT/US2020/066975

§ 371 Date: May 22, 2023

(51) Int. Cl. B41J 11/00

(52) U.S. Cl. CPC B41J 11/0095; B41J 11/008; B41J 2203/011

(57) ABSTRACT

A printing apparatus is disclosed herein. The apparatus comprises a platform defining a printing zone to hold a media moveable along a media path direction; a first sensor at a first location along the media path direction to measure a media advance at the first location; a second sensor located at a second location along the media path direction downstream the first location, the second sensor to measure the media advance at the second location; and a controller. The controller to determine a deformation gradient of the media based on a first set of measurements of the media advance by the sensors at the first and second locations and adjust an image to be printed based on the deformation gradient.

### BACKGROUND

Printers are devices that record images on a printing media. Printers comprise printheads in a carriage that selectively propel an amount of printing fluid on the media. Some printers may include internal printing fluid reservoirs. Other printers may use external printing fluid cartridges as printing fluid reservoirs.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1A is a schematic diagram showing an example of a top view of a printing apparatus with a media thereon;

FIG. 1B is a schematic diagram showing another example of a top view of a printing apparatus with a plurality of media thereon;

FIG. 2 is a flowchart of an example method for adjusting an image to be printed based on a deformation gradient;

FIG. 3 is a flowchart of another example method for adjusting an image to be printed based on an initial deformation and a deformation gradient;

FIG. 4 is a flowchart of another example method for adjusting an image to be printed based on a plurality of deformation gradients; and

FIG. 5 is a block diagram showing a processor-based system example to adjust an image to be printed.

### DETAILED DESCRIPTION

The following description is directed to various examples of printing systems. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As used herein, the terms “about” and “substantially” are used to provide flexibility to a range endpoint by providing that a given value may be, for example, an additional 15% more or an additional 15% less than the endpoints of the range. In another example, the range endpoint may be an additional 30% more or an additional 30% less than the endpoints of the range. The degree of flexibility of this term can be dictated by the particular variable and would be within the knowledge of those skilled in the art to determine based on experience and the associated description herein.

For simplicity, it is to be understood that in the present disclosure, elements with the same reference numerals in different figures may be structurally the same and may perform the same functionality.

Printing apparatuses, such as printers, comprise a carriage having elements to selectively propel an amount of printing fluid on a media. In some printers, the carriage is a fixed carriage spanning at least the full width of the printable area of the media, such that as the media travels underneath, some elements from the carriage propel the printing fluid and thereby generate the image to be recorded on the media. In other examples, however, the carriage is a scanning carriage which does not span the full width of the printable area of the media. The scanning carriage is therefore controllable to scan across the full width of the printable area of the media (i.e., scanning direction) and to selectively propel the printing fluid on the media. These apparatuses are commonly referred to as scanning printers.

Some printing apparatuses comprise an input roller to host a media roll to be supplied to the printing area. Additionally, some examples further comprise an output roller in which the printed media is rolled. Both input and output rollers may generate a tension to the media such that the media is stretched on the printing area. In addition, different media have different degrees of stretchability (i.e., deformation upon being stretched) which causes a relative displacement between the media input and output from the printing area. Some media have a non-uniform stretchability based on, for example, the non-uniform media advancement of scanning printers, non-uniform input and output roller radius during printing, ambient temperature and humidity, and the like. Some printing media have different degrees of stretchability in its width, length and directions in-between (e.g., diagonals). Some examples of media may have a degree of deformation due to stretchability up to 5% in width and up to 10% in length with respect to its original non-stretched length. This may be caused due to the movement of the fibers within the media upon the application of a tension force.

Media with high stretchability may present print quality challenges, as the media deformation on the printing zone causes a deformation in the printed image. Specifically, if a printed image is recorded on a stretched media, once the media is unstretched, the image may distort. In some examples, the degree of deformation may not be a constant parameter and may be therefore challenging to calculate. The degree of deformation varies between different media types and even between different rolls of the same media type. These challenges are even more apparent in discrete media advancement printing systems, such as in scanning printers.

Some printers may accommodate a plurality of printing media of different thicknesses, stretchability and rigidity values. Some printing media may include paper, textile, vinyl, wood, methacrylate, other plastics, ceramic, foam, metal or composites. Variability in media therefore has an influence on the degree of deformation of such media due to stretchability.

In the examples herein, the terms “width” and “length” have been used. The two terms are intended to denote two substantially orthogonal directions within a horizontal plane. In further examples, the terms width and length may be used interchangeably. Furthermore, the terms “laterally” and “vertically” have been used. These terms are intended to further denote two substantially orthogonal directions, where laterally is a direction within the horizontal plane and vertically is the orthogonal direction from the horizontal plane (e.g., normal vector). In some examples herein, the “vertical” direction is further referred to media path direction, and the “horizontal” directions is further referred to as scanning direction.

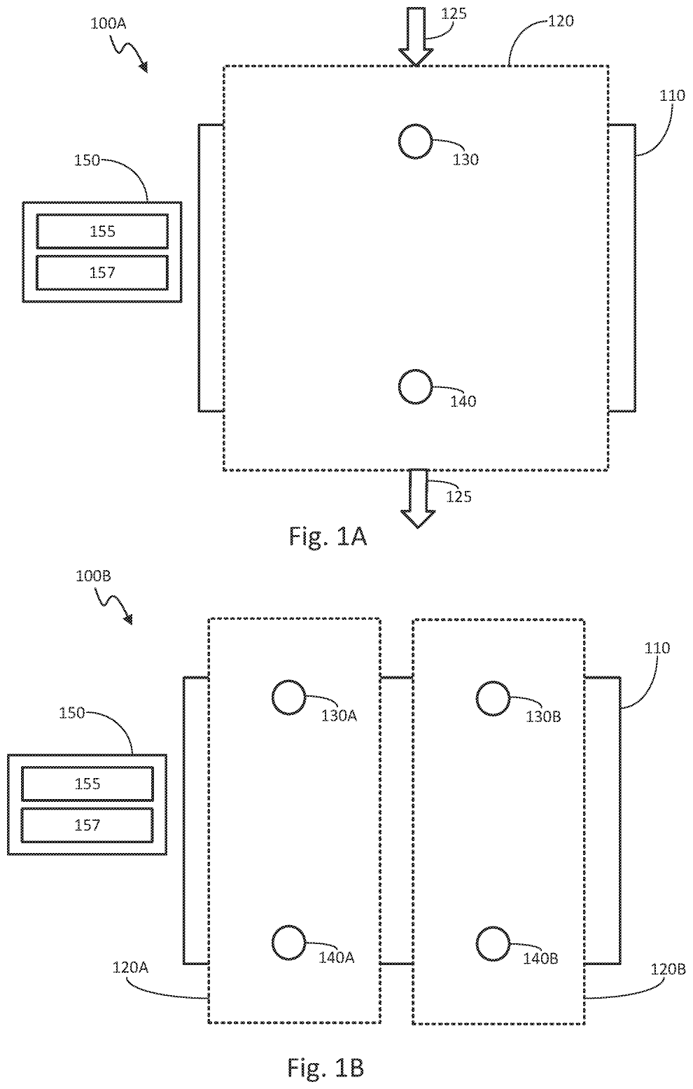

Referring now to the drawings, FIG. 1A-1B are schematic diagrams showing examples of top views of a printing apparatus 100A and 100B respectively, such as a printer.

The apparatuses 100A-B comprise a platform 110 defining a printing zone. The printing zone is the printable area on the platform 110 which is reachable by a carriage to record an image to a media located thereon. The platform 110 is to hold a media 120. The media 120 is to move along the length of the platform 110, for example, in a media path direction 125. In the examples herein, the media 120 has been illustrated in dotted lines for clarity purposes, as it is an external element from the apparatuses 100A-B that interacts with the apparatuses 100A-B (e.g., the media may not be present during transportation of the apparatuses 100A-B). In some examples, such as the example depicted in FIG. 1A, the width of the media 120 covers substantially the full printable area on the platform 110. In other examples such as the example depicted in FIG. 1B, however, the width of the media 120A covers a portion of the printable area on the platform 110. In yet other examples, the platform 110 is to hold a plurality of medias 120A-B, the width of the combined plurality of media 120 covering, at most, substantially the entire printable area on the platform 110.

In some examples, the platform 110 is a static platform. In other examples, parts of the platform 110 may be moveable, for example horizontally. Additionally, in further examples, the platform 110 may be a porous platen fluidically connectable to a vacuum source (not shown) such that, when in use, the vacuum source is controlled to cause vacuum conditions to the at least the print area of the platform 110. In some examples, the porous platen may be implemented as a solid platform 110 made out of a porous material with air pockets to enable air to traverse therethough. In other examples, however, the platform 110 may include a set of perforations or pores of a predefined size or set of predefined sizes distributed across the surface of the platform 110 in fluid communication with the vacuum source, the pores or perforations to enable air to traverse therethrough. The vacuum conditions provide a suction force to the media 120 such that substantially the entire lower surface of the media 120 sticks to the upper surface of the platform 110, thereby substantially inhibiting a vertical movement of the media 110.

In some examples, the apparatuses 100A-B comprise a carriage (not shown) including a set of printheads in fluid communication with a set of printing fluids from a supply or cartridge. Some examples of printheads may include thermal inkjet printheads, piezoelectrical printheads, or any suitable type of printhead. In some examples, the printheads are removable printheads. In other examples, the printheads are an integral part of the carriage. The supply is an external element from the apparatuses 100A-B. In some examples, the supply is to be hosted in the carriage, for example in a designated slot within the carriage. In other examples, the supply is to be hosted away from the carriage with fluid pathways that fluidically connect the supply with carriage and/or the printheads within the carriage.

In some examples, the carriage may be controllable to move laterally along a scanning direction (i.e., substantially orthogonal to the media path direction 125) and over the platform 110. In other examples, however, the carriage may not be moveable. When in use, the carriage is further controllable such that the printheads selectively eject amount of a set of printing fluids on the media 120 based on previously received print job data. The print job data may be a digital product including the images and/or text to be recorded on the media. The print job data may be received in a plurality of digital formats, such as JPEG, TIFF, PNG, PDF and the like.

In some examples, the printheads may eject a plurality of printing fluids. A printing fluid may be a solution of pigments dispersed in a liquid carrier such as water or oil. Some recording printing fluids may include Black ink, White ink, Cyan ink, Yellow ink, Magenta ink, Red ink, Green ink, and/or Blue ink. Other non-recording printing fluids may be used to provide additional properties to the printing fluids ejected on the media 120, for example, resistance to light, heat, scratches, and the like.

The apparatuses 110A-B include a plurality of sensors 130-140 located along the media path direction 125. The plurality of sensors 130-140 are controllable to measure the advance of the media 120 at the locations in which the sensors 130-140 are located thereto. The sensors 130-140 may be any sensors which are suitable for measuring the advance of the media 120, for example by measuring movement, displacement, position, velocity and/or acceleration. Examples of the sensors 130-140 may include optical sensors (e.g., Optical Media Advance Sensor (OMAS), PIXART sensor), mechanical sensors (e.g., rotary encoder), or capacitive sensors. The sensors may be located above or below the moveable media 120.

In the example of FIG. 1A, the apparatus 110A comprises a first sensor 130 at a first location to measure the media 120 advance at the first location, and a second sensor 140 at a second location along the media path direction 125 downstream the first location to measure the media advance at the second location. In some examples, the first location may be located at a media input location above the printing area and the second location may be located at a media output location above the printing area. In other examples, the first and second sensors may be located at respective positions between the media input and output locations above the printing area.

In the example of FIG. 1B, the apparatus 100B comprises additional sensors with respect to apparatus 100A from FIG. 1A. The apparatus 100B comprises a first and second sensors 130A and 140A, and a third and fourth sensors 130B and 140B. The first and second sensors (130A-140A) are located at a first and second locations along the media path direction 125, where the second location is downstream with respect to the first location. The first and second sensors (130A-140A) are controllable to measure a media advance from a first media 120A at the first and second locations respectively. The third and fourth sensors (130B-140B) are located at a third and fourth locations along the media path direction 125, where the fourth location is downstream with respect to the third location. In some examples, the third and fourth sensors (130B-140B) may be located in parallel to the first and second sensors (130A-140A) along the media path direction. The third and fourth sensors (130B-140B) are controllable to measure a media advance from a second media 120B at the first and second locations respectively. In some examples, the first and second medias 120A-B may have at least one of a different composition, width, thickness, velocity and the like. In other examples, the first and second medias 120A-B may have at least one of the same composition, width, thickness, velocity and the like.

The sensors (130-140, 130A-B, 140A-B), the movement of the carriage, the printheads, and the movement of the media may be controlled by a set of electronic components, such as a processor, a CPU, a SoC, a FPGA, a PCB and/or a controller. In the examples herein, a controller 150 may be understood as any combination of hardware and programming that may be implemented in a number of different ways. For example, the programming of modules may be processor-executable instructions stored in at least one non-transitory machine-readable storage medium 155 and the hardware for modules may include at least one processor 157 to execute those instructions. In some examples described herein, multiple modules may be collectively implemented by a combination of hardware and programming. In other examples, the functionalities of the controller may be, at least partially, implemented in the form of an electronic circuitry. A controller may be further understood as a distributed controller, a plurality of controllers, and the like.

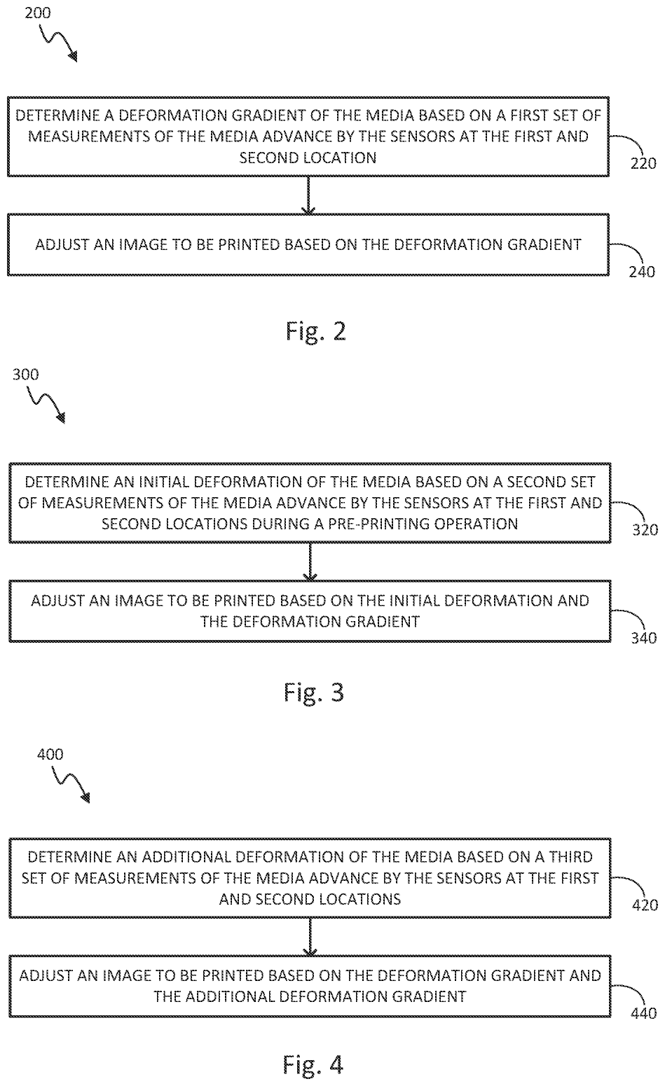

FIG. 2 is a flowchart of an example method 200 for adjusting an image to be printed based on a deformation gradient. The method 200 may involve previously disclosed elements from FIGS. 1A-B referred to with the same reference numerals. In some examples, parts of the method 200 may be executed by a controller, such as controller 150 from FIGS. 1A-B.

During a printing operation, the controller 150 may control the first and second sensors 130-140 to measure a first set of measurements of the media advance including a media advance measurement by the first sensor 130 at the first location and a media advance measurement by the second sensor 140 at the second location. The media advance measurement may include a reading of a parameter used to determine the displacement of the media advance in a predetermined period of time (e.g., window time). Some of these parameters may include, displacement, velocity, acceleration and/or position.

At block 220, the controller 150 determines a deformation gradient of the media 120 based on the first set of measurements of the media advance, measured by the first and second sensors 130-140 at the first and second locations. In the examples herein, a deformation gradient may be understood as a parameter indicative of the displacement difference between the displacement of the media 120 at the first location and the displacement of the media 120 at the second location.

In the examples herein, a print pass may be understood as the printing operation in which a carriage moves from an edge of a width of the media 120 to the opposite edge of the width of the media 120. The printing apparatus may control the media 120 to advance in a discrete manner between two consecutive print passes. In some examples in which the printer is a scanning printer, the controller 150 is to determine the deformation gradient of the media 120 in a print pass basis, since the discrete advancement of the media in a print pass may involve higher deformations due to media stretchability as opposed to continuous printing. In other examples, however, the controller 150 is to determine the deformation gradient of the media 120 on the basis of a predefined distance travelled by the media 120 or a predefined period of time. The predefined distance or the predefined period of time may be encoded to the memory 155 of the controller 150 before the printing operation or may be accessed by means of a look up table (LUT) stored either in the memory 155 of the controller 150 or in an external wireless data repository such as the cloud.

It is to be noted that the deformation gradient is indicative of the difference of tensions applied to the media 120 in the different locations within the print zone as well as the effect of the characteristic stretchability of the media 120. At block 240, the controller 150 is to adjust an image to be printed based on the deformation gradient, such that when the media becomes unstretched after the printing operation (e.g., releasing the tension), the resulting unstretched image is as closely as possible to the original unadjusted image data product received by the controller 150.

FIG. 3 is a flowchart of another example method 300 for adjusting an image to be printed based on an initial deformation and a deformation gradient. The method 300 may involve previously disclosed elements from FIGS. 1A-B referred to with the same reference numerals. In some examples, parts of the method 300 may be executed by a controller, such as controller 150 from FIGS. 1A-B. In some examples, parts of method 300 may be executed before block 220 of method 200.

Before the printing operation, the media 120 (e.g., a media 120 roll) is loaded into the printing apparatus 100A. Part of the media 120 is then placed on the platform 110 and some initial tension is applied such that the media 120 is moveable along the media path direction 125, thereby inhibiting substantially any vertical and lateral movement of the media 120 on the platform 110. This initial tension may additionally deform the media 120 due to the characteristic stretchability of the media 120.

At block 320, the controller 150 determines an initial deformation of the media 120 based on a second set of measurements of the media 120 advance by the sensors 130-140 at the first and second locations respectively. The second set of measurements may be similar to the first set of measurements disclosed with reference to FIG. 2. The second set of measurements may be read during a pre-printing operation, such as after the application of the initial tension after the media 120 loading operation. The second set of measurements may be indicative of the initial deformation due to the initial tension and the characteristic media 120 stretchability.

In some examples, the processor 157 of the controller 150 may calculate the initial deformation based on the second set of measurements. In other examples, the controller 150 may access an external database, such as a LUT, to determine the initial deformation of the media 120 based on the second set of measurements.

When the media 120 is loaded into the printing apparatus 100A and then tensed, after the application of the tension, the media 120 may take some time to stabilize and reach a movement stationary regime. In some examples, the controller 150 may further control the first and second sensors 130-140 to measure the second set of measurements when the media 120 is stabilized. In some examples, the controller 150 may determine that the media 120 is stabilized once the speed of the media at the first and second locations is substantially zero. In some examples in which the printing apparatus 100A is a scanning printer, the controller 150 may control the first and second sensors 130-140 to measure the first set of measurements (e.g., block 220 of FIG. 2) when the media 120 is stabilized after a discrete advancement of the media 120 in a print pass.

At block 340, the controller 150 is to adjust the image to be printed based on the initial deformation and the deformation gradient, such that when the media 120 becomes unstretched after the printing operation, the resulting unstretched image is as closely as possible to the original unadjusted image data product received by the controller 150. Parts of block 340 may be similar to block 240 disclosed with reference to FIG. 2.

In some examples, after block 320, the controller 150 is to determine an unstretched length of the media 120 based on the initial deformation, the deformation gradient, and the length of the print zone. In the examples herein, the unstretched length of the media 120 may be understood as the length of at least a portion of the media 120 when the applied tension is released. The controller 150 may then determine a deformation coefficient based on the unstretched length of the media 120. In an example, the deformation coefficient may be calculated as a ratio between the unstretched length of the media 120 and the length of the printed zone. In these examples, at block 340, the controller 150 may adjust the image data product to be printed based on the deformation coefficient.

FIG. 4 is a flowchart of another example method 400 for adjusting an image to be printed based on a plurality of deformation gradients. The method 400 may involve previously disclosed elements from FIGS. 1A-B referred to with the same reference numerals. In some examples, parts of the method 400 may be executed by a controller, such as controller 150 from FIGS. 1A-B. In some examples, parts of method 400 may be executed after block 220 of method 200. Additionally, method 400 may also include elements from method 300 such as block 320.

At block 420, the controller 150 determines an additional deformation gradient of the media 120 based on a third set of measurements of the media 120 advance by the sensors 130-140 at the first and second locations. The third set of measurements may be similar to the first set of measurements disclosed with reference to FIG. 2. The third set of measurements may be taken during a printing operation but in a different timeframe than the first set of measurements. In an example the first and third sets of measurements may be taken respectively at each of two consecutive print passes. In another example, the first and third sets of measurements may be taken between a predetermined advancement of the media 120 or between a predetermined timeframe.

At block 440, the controller 150 adjusts the image to be printed based on the deformation gradient and the additional deformation gradient. Parts of block 440 may similar than parts of block 240 disclosed with reference to FIG. 2. In some instances, the first set of measurements may include some reading errors. Using additional sets of measurements and their associated deformation gradients to adjust the image data product to be printed enables a mitigation of the reading error of a single set of measurements.

In additional examples, the controller 150 may control the first and second sensors 130-140 to take a plurality of sets of measurements of the media 120 advance during the printing operation. The controller 150 may then determine a plurality of deformation gradients of the media 150 based on the plurality of sets of measurements of the media 120 advance (e.g., block 420). The controller 150, may then determine a rolling average or a similar mathematical operation (e.g., weighted rolling average) of the latest of a predetermined number of the plurality of deformation gradients. In some examples, the controller 150 may determine the rolling average of the last 10, 7, 5 or 3 available deformation gradients or any discrete number in-between. The controller 150 may then adjust the image data product to be printed based on the rolling average of the latest of the predetermined number of deformation gradients (e.g., block 440). These examples enable the controller 150 to adjust the image data product taking into account the deformation gradients determined in previous iterations even though the deformation gradient of the latest iteration is not available (not determined) yet due to computation time. Accordingly, this speeds up the process leaving no printing downtimes due to computation times.

It is to be noted that the examples disclosed with reference to FIGS. 2-4 may also be applied to the architecture of the printing apparatus 100B of FIG. 1B. Thereby, the sensors 130-140 being equated to sensors 130A-140A and/or 130B-140B; and media 120 being equated to media 120A and/or media 120B.

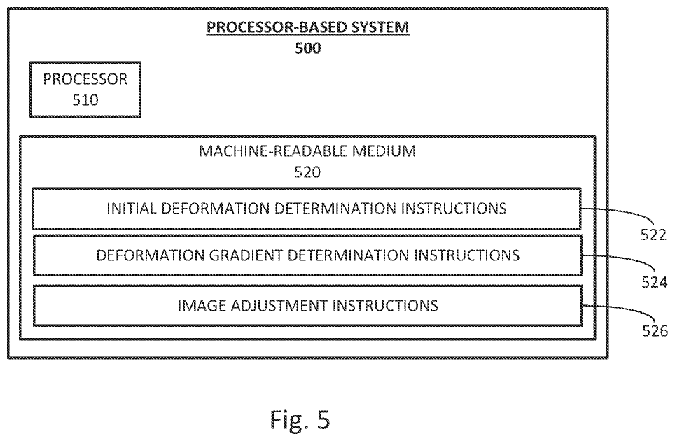

FIG. 5 is a block diagram showing a processor-based system 500 example to adjust an image to be printed. In the examples herein, the instructions of system 500 may involve previously disclosed elements from FIGS. 1A-1B, 2-4 referred to with the same reference numerals.

In some implementations, the system 500 may be or may form part of a computing unit within a 3D printing system or facility. In some implementations, the system 500 is a processor-based system and may include a processor 510 coupled to a machine-readable medium 520. The processor 510 may include a single-core processor, a multi-core processor, an application-specific integrated circuit (ASIC), a field programmable gate array (FPGA), and/or any other hardware device suitable for retrieval and/or execution of instructions from the machine-readable medium 520 (e.g., instructions 522-526) to perform functions related to various examples. Additionally, or alternatively, the processor 510 may include electronic circuitry for performing the functionality described herein, including the functionality of instructions 522-526. With respect of the executable instructions represented as boxes in FIG. 5, it should be understood that part or all of the executable instructions and/or electronic circuits included within one box may, in alternative implementations, be included in a different box shown in the figures or in a different box not shown.

The machine-readable medium 520 may be any medium suitable for storing executable instructions, such as a random-access memory (RAM), electrically erasable programmable read-only memory (EEPROM), flash memory, hard disk drives, optical disks, and the like. In some example implementations, the machine-readable medium 520 may be a tangible, non-transitory medium, where the term “non-transitory” does not encompass transitory propagating signals. The machine-readable medium 520 may be disposed within the processor-based system 500, as shown in FIG. 5, in which case the executable instructions may be deemed “installed” on the system 500. Alternatively, the machine-readable medium 520 may be a portable (e.g., external) storage medium, for example, that allows system 500 to remotely execute the instructions or download the instructions from the storage medium. In this case, the executable instructions may be part of an “installation package”. As described further herein below, the machine-readable medium may be encoded with a set of executable instructions 522-526.

Instructions 522, when executed by the processor 510, may cause the processor 510 to determine an initial deformation of a printing media 120 on a print zone from a printing apparatus 100A based on a second set of measurements of the media advance read by a plurality of sensor (e.g., first and second sensors 130, 140) located at a plurality of different positions along a media path direction 125.

Instructions 524, when executed by the processor 510, may cause the processor 510 to determine a deformation gradient of the media 120 based on a first set of measurements of the media advance 125 read by the plurality of sensors (130, 140).

Instructions 526, when executed by the processor 510, may cause the processor 510 to adjust an image to be printed based on the initial deformation and the deformation gradient. The image data product may be adjusted such that once the media is in an unstretched condition, the recorded image on the media is not distorted due to the media deformation during printing.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A printing apparatus comprising:
a platform defining a printing zone to hold a media moveable along a media path direction;
a first sensor at a first location along the media path direction to measure a media advance at the first location;
a second sensor located at a second location along the media path direction downstream the first location, the second sensor to measure the media advance at the second location; and
a controller to:
   determine a deformation gradient of the media based on a first set of measurements of the media advance by the sensors at the first and second locations; and
   adjust an image to be printed based on the deformation gradient.

Feature set 2: A printing apparatus with feature set 1, wherein the controller is further to: determine an initial deformation of the media based on a second set of measurements of the media advance by the sensors at the first and second locations during a pre-printing operation; and adjust the image to be printed based on the initial deformation and the deformation gradient.

Feature set 3: A printing apparatus with any preceding feature set 1 to 2, wherein the controller is further to: determine an unstretched length of the media based on the initial deformation and the deformation gradient; determine a deformation coefficient based on the unstretched length; and adjust the image to be printed based on the deformation coefficient.

Feature set 4: A printing apparatus with any preceding feature set 1 to 3, wherein the controller is to control the first and second sensors to measure the second set of measurements when the media is stabilized.

Feature set 5: A printing apparatus with any preceding feature set 1 to 4, wherein the controller is to determine that the media is stabilized once the speed of the media at the first and second locations is substantially zero.

Feature set 6: A printing apparatus with any preceding feature set 1 to 5, wherein the printing apparatus is a scanning printer and the controller is to determine the deformation gradient of the media in a print pass basis.

Feature set 7: A printing apparatus with any preceding feature set 1 to 6, wherein the controller is to determine the deformation gradient of the media on the basis of a predefined distance travelled by the media or a predefined period of time.

Feature set 8: A printing apparatus with any preceding feature set 1 to 7, wherein the controller is to: determine an additional deformation gradient of the media based on a third set of measurements of the media advance by the sensors at the first and second locations; and adjust an image to be printed based on the deformation gradient and the additional deformation gradient.

Feature set 9: A printing apparatus with any preceding feature set 1 to 8, wherein the controller is to: determine a plurality of deformation gradients of the media based on a plurality of sets of measurements of the media advance; determine a rolling average of the latest of a predetermined number of the deformation gradients; and adjust the image to be printed based on the determined rolling average.

Feature set 10: A printing apparatus with any preceding feature set 1 to 9, further comprising a third and fourth sensors located in parallel to the first and second sensors respectively along the media path direction.

Feature set 11: A method comprising:
determining a deformation gradient of a printing media on a print zone from a printing apparatus based on a first set of measurements of a media advance by a plurality of sensors located at different positions along a media path direction; and
adjusting an image to be printed based on the deformation gradient.

Feature set 12: A method with feature set 11, further comprising: determining an initial deformation of the media based on a second set of measurements of the media advance read by a plurality of sensors at a plurality of locations along a media path direction; and adjusting the image to be printed based on the initial deformation and the deformation gradient.

Feature set 13: A method with any of preceding feature set 11 to 12, further comprising: determining an unstretched length of the media based on the initial deformation and the deformation gradient; determining a deformation coefficient based on the unstretched length; and adjusting the image to be printed based on the deformation coefficient.

Feature set 14: A non-transitory machine-readable medium storing instructions executable by a processor, the non-transitory machine-readable medium comprising:
instructions to determine an initial deformation of a printing media on a print zone from a printing apparatus based on a second set of measurements of the media advance read by a plurality of sensors located at a plurality of different positions along a media path direction;
instructions to determine a deformation gradient of the media based on a first set of measurements of a media advance read by the plurality of sensors; and
   instructions to adjust the image to be printed based on the initial deformation and the deformation gradient.

Feature set 15: A non-transitory machine-readable medium with feature set 14, further comprising: instructions to determine an unstretched length of the media based on the initial deformation and the deformation gradient; instructions to determine a deformation coefficient based on the unstretched length; and instructions to adjust the image to be printed based on the deformation coefficient.

What it is claimed is:

1. A printing apparatus comprising:
a platform defining a printing zone to hold a media moveable along a media path direction;
a first sensor at a first location along the media path direction to measure a media advance at the first location;
a second sensor located at a second location along the media path direction downstream the first location, the second sensor to measure the media advance at the second location; and
a controller to:
determine a deformation gradient of the media based on a first set of measurements of the media advance by the sensors at the first and second locations; and
adjust an image to be printed based on the deformation gradient.

2. The printing apparatus of claim 1, wherein the controller is further to:
determine an initial deformation of the media based on a second set of measurements of the media advance by the sensors at the first and second locations during a pre-printing operation; and
adjust the image to be printed based on the initial deformation and the deformation gradient.

3. The apparatus of claim 2, wherein the controller is further to:
determine an unstretched length of the media based on the initial deformation and the deformation gradient;
determine a deformation coefficient based on the unstretched length; and
adjust the image to be printed based on the deformation coefficient.

4. The apparatus of claim 2, wherein the controller is to control the first and second sensors to measure the second set of measurements when the media is stabilized.

5. The apparatus of claim 4, wherein the controller is to determine that the media is stabilized once the speed of the media at the first and second locations is substantially zero.

6. The apparatus of claim 1, wherein the printing apparatus is a scanning printer and the controller is to determine the deformation gradient of the media in a print pass basis.

7. The apparatus of claim 1, wherein the controller is to determine the deformation gradient of the media on the basis of a predefined distance travelled by the media or a predefined period of time.

8. The apparatus of claim 1, wherein the controller is to:
determine an additional deformation gradient of the media based on a third set of measurements of the media advance by the sensors at the first and second locations; and
adjust an image to be printed based on the deformation gradient and the additional deformation gradient.

9. The apparatus of claim 8, wherein the controller is to:
determine a plurality of deformation gradients of the media based on a plurality of sets of measurements of the media advance;
determine a rolling average of the latest of a predetermined number of the deformation gradients; and
adjust the image to be printed based on the determined rolling average.

10. The apparatus of claim 1, further comprising a third and fourth sensors located in parallel to the first and second sensors respectively along the media path direction.

11. A method comprising:
determining a deformation gradient of a printing media on a print zone from a printing apparatus based on a first set of measurements of a media advance by a plurality of sensors located at different positions along a media path direction; and
adjusting an image to be printed based on the deformation gradient.

12. The method of claim 11, further comprising:
determining an initial deformation of the media based on a second set of measurements of the media advance read by a plurality of sensors at a plurality of locations along a media path direction; and
adjusting the image to be printed based on the initial deformation and the deformation gradient.

13. The method of claim 12, further comprising:
determining an unstretched length of the media based on the initial deformation and the deformation gradient;
determining a deformation coefficient based on the unstretched length; and
adjusting the image to be printed based on the deformation coefficient.

14. A non-transitory machine-readable medium storing instructions executable by a processor, the non-transitory machine-readable medium comprising:
instructions to determine an initial deformation of a printing media on a print zone from a printing apparatus based on a second set of measurements of the media advance read by a plurality of sensors located at a plurality of different positions along a media path direction;
instructions to determine a deformation gradient of the media based on a first set of measurements of the media advance read by the plurality of sensors; and
instructions to adjust an image to be printed based on the initial deformation and the deformation gradient.

15. The machine-readable medium of claim 14, further comprising:
instructions to determine an unstretched length of the media based on the initial deformation and the deformation gradient;
instructions to determine a deformation coefficient based on the unstretched length; and
instructions to adjust the image to be printed based on the deformation coefficient.
